(19) United States
(12) Patent Application Publication
(10) Pub. No.: US 2025/0047010 A1
(43) Pub. Date: Feb. 6, 2025

(54) ANTENNA STRUCTURE AND MANUFACTURING METHOD THEREFOR

(71) Applicant: ZTE CORPORATION, Shenzhen (CN)

(72) Inventors: Weiming XU, Shenzhen (CN); Jie CHEN, Shenzhen (CN); Weiwei YANG, Shenzhen (CN); Feng WANG, Shenzhen (CN)

(21) Appl. No.: 18/691,176

(22) PCT Filed: Mar. 14, 2022
(86) PCT No.: PCT/CN2022/080748

§ 371 Date: Mar. 12, 2024

(30) Foreign Application Priority Data
Sep. 13, 2021 (CN) 202111066841.9

(51) Int. Cl. H01Q 21/06; H01Q 21/00

(52) U.S. Cl. CPC H01Q 21/062; H01Q 21/0087

(57) ABSTRACT

An antenna structure and a manufacturing method therefor are disclosed. The antenna structure may include: a feed power dividing plate provided with a slot, an inner wall of the slot is metallized, and pads are arranged on two sides of the slot; and an isolating bar provided with a pin configured to be inserted into the slot, the isolating bar being welded to the feed power dividing plate through the pads based on a through-hole reflow soldering process.

### CROSS-REFERENCE TO RELATED APPLICATION

This application is a national stage filing under 35 U.S.C. § 371 of international application number PCT/CN2022/080748, filed Mar. 14, 2022, which claims priority to Chinese patent application No. 202111066841.9, filed Sep. 13, 2021. The contents of these applications are incorporated herein by reference in their entirety.

### TECHNICAL FIELD

Embodiments of the present disclosure relate to the technical field of 5G base station antennas, and more particularly, to an antenna structure and a manufacturing method therefor.

### BACKGROUND

For a Massive Multiple Input Multiple Output (MIMO) base station antenna array, in order to achieve wider beam scanning and suppress the level of grating lobes, adding an isolating bar on a feed power dividing plate can improve the electromagnetic environment and effectively improve the isolation. On the one hand, a reflection path is additionally provided to realize electromagnetic field cancellation, and on the other hand, electromagnetic coupling between adjacent arrays is reduced.

In some technical schemes, the isolating bar is welded by means of manual soldering iron drag welding, which belongs to surface welding, that is, drag soldering is performed on the pads of the feed power dividing plate by using a soldering iron, and the isolating bar is welded to the feed power dividing plate by means of a manual welding method. However, at present, this manual welding technique suffers from low production efficiency, high labor requirements, and inconsistent quality.

### SUMMARY

The following is an overview of the subject described in detail herein. This overview is not intended to limit the scope of protection of the claims.

Embodiments of the present disclosure provide an antenna structure and a manufacturing method therefor.

In accordance with a first aspect of the present disclosure, an embodiment provides an antenna structure, including: a feed power dividing plate provided with a slot, an inner wall of the slot is metallized, and pads are arranged on two sides of the slot; and an isolating bar provided with a pin configured to be inserted into the slot, the isolating bar being welded to the feed power dividing plate through the pads based on a through-hole reflow soldering process.

In accordance with a second aspect of the present disclosure, an embodiment provides an electronic device, including the antenna structure as described in the first aspect above.

In accordance with a third aspect of the present disclosure, an embodiment provides a manufacturing method for the antenna structure which includes a feed power dividing plate and an isolating bar, the feed power dividing plate is provided with a slot, an inner wall of the slot is metallized, pads are arranged on two sides of the slot, and the isolating bar is provided with a pin, the manufacturing method comprising: printing solder paste on the pads; inserting the pin into the slot; and welding the isolating bar to the feed power dividing plate through the pads by means of a through-hole reflow soldering process.

Other features and advantages of the present disclosure will be set forth in the following description, and will be partly apparent from the description or understood by implementing the present disclosure. The objects and other advantages of the present disclosure can be realized and obtained by the structure particularly pointed out in the description, claims and drawings.

### BRIEF DESCRIPTION OF DRAWINGS

The drawings are provided for a further understanding of the technical schemes of the present disclosure, and constitute a part of the description. The drawings and embodiments of the present disclosure are used to illustrate the technical schemes of the present disclosure, and do not constitute a limitation to the technical schemes of the present disclosure.

FIG. 1 is a structure separation diagram of an antenna structure provided by an embodiment of the present disclosure;

FIG. 2 is an overall structural diagram of an antenna structure provided by an embodiment of the present disclosure; and

FIG. 3 is a flowchart of a manufacturing method for the antenna structure provided by an embodiment of the present disclosure.

### DETAILED DESCRIPTION

To make the objects, technical schemes, and advantages of the present disclosure clear, the present disclosure will be further described in detail in conjunction with the drawings and embodiments. It should be understood that the specific embodiments described here are only used to illustrate the present disclosure, and are not used to limit the present disclosure.

It should be understood that in the description of the embodiments of the present disclosure, the meaning of “a plurality of” (or multiple) is two or more. “Greater than”, “less than”, “exceeding”, etc., preceding a number are understood to exclude this number, while “above”, “below”, “within”, etc., are understood to include this number. “First”, “second” and the like are only used for the purpose of distinguishing technical features, and are not intended to indicate or imply relative importance or imply the number of indicated technical features or imply a precedence order of the indicated technical features.

For a Massive MIMO base station antenna array, in order to achieve wider beam scanning and suppress the level of grating lobes, adding an isolating bar on a feed power dividing plate can improve the electromagnetic environment and effectively improve the isolation. On the one hand, a reflection path is additionally provided to realize electromagnetic field cancellation, and on the other hand, electromagnetic coupling between adjacent arrays is reduced.

In some technical schemes, the isolating bar is welded by means of manual soldering iron drag welding, which belongs to surface welding, that is, drag soldering is performed on the pads of the feed power dividing plate by using a soldering iron, and the isolating bar is welded to the feed power dividing plate by means of a manual welding method. However, at present, this manual welding technique suffers from low production efficiency, high labor requirements, and inconsistent quality.

In view of the above problems existing in some technical schemes, embodiments of the present disclosure provide an antenna structure and a manufacturing method therefor. The antenna structure includes a feed power dividing plate and an isolating bar. The feed power dividing plate is provided with a slot, an inner wall of the slot is metallized, and pads are arranged on two sides of the slot. The isolating bar is provided with a pin configured to be inserted into the slot, and the isolating bar is welded to the feed power dividing plate through the pads based on a through-hole reflow soldering process. On this basis, the feed power dividing plate of the present disclosure is provided with a slot, an inner wall of the slot is metallized, pads are arranged on two sides of the slot. The isolating bar is provided with a pin which, when welding, is inserted into the slot, and then the isolating bar is welded to the feed power dividing plate through the pads based on the through-hole reflow soldering process. Compared with the manual welding method in some technical schemes, the present disclosure has the advantages that batch automatic production can be achieved, and production efficiency can be improved, thereby reducing the production and manufacturing costs of products, and improving the quality stability of products.

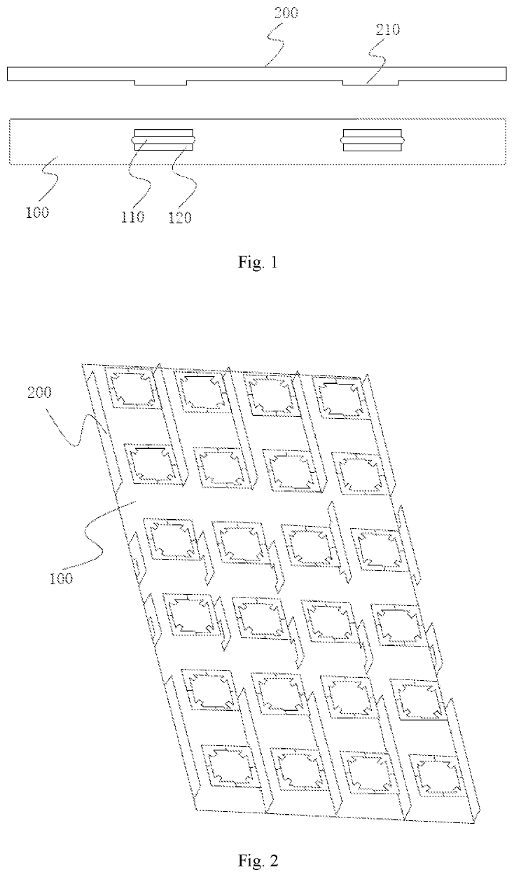

FIG. 1 is a structure separation diagram of an antenna structure provided by an embodiment of the present disclosure. As shown in FIG. 1, the antenna structure includes a feed power dividing plate 100 and an isolating bar 200. The feed power dividing plate 100 is provided with a slot 110, an inner wall of the slot 110 is metallized, and pads 120 are arranged on two sides of the slot 110. The isolating bar 200 is provided with a pin 210 configured to be inserted into the slot 110, and the isolating bar 200 is welded to the feed power dividing plate 100 through the pads 120 based on a through-hole reflow soldering process. On this basis, the feed power dividing plate 100 is provided with a slot 110, an inner wall of the slot 110 is metallized, for example, the inner wall of the slot 110 may be provided with a copper layer, and pads 120 are arranged on two sides of the slot 110. The isolating bar 200 is provided with a pin 210 which, when welding, is inserted into the slot 110, and then the isolating bar 200 is welded to the feed power dividing plate 100 through the pads 120 based on the through-hole reflow soldering process. For example, the isolating bar 200 may be welded to the feed power dividing plate 100 through the pads 120 by means of a Surface Mounted Technology (SMT) reflow oven. Therefore, the present disclosure can achieve batch automatic production, and can improve production efficiency, thereby reducing the production and manufacturing costs of products and improving the quality stability of products.

It should be noted that design specifications of the isolating bar 200 may be made according to actual needs. In order to facilitate SMT welding, design specifications of the isolating bar 200 may be as follows: the isolating bar 200 has a height between 8 mm and 15 mm, a thickness between 1 mm and 2 mm, and a length designed according to actual needs; and the pin 210 of the isolating bar 200 has a height between 1 mm and 2 mm and a length between 6 mm and 15 mm, and the number of pins 210 is designed to be between 2 and 4. Moreover, the isolating bar 200 may be made of a Printed Circuit Board (PCB). In addition, the isolating bar 200 is cladded with copper on both sides, with a copper thickness ranging from 17 μm to 35 μm, and is subjected to immersion tin surface treatment.

It should be noted that the design specifications of the feeding power dividing plate 100 should be matched with the design specifications of the isolating bar 200. Based on this, the design specifications of the isolating bar 200 may be as follows: the slot 110 of the feed power dividing plate 100 has a width 0.25 mm greater than the thickness of the isolating bar 200, the feed power dividing plate 100 has a length 0.5 mm greater than that of the pin 210, and the number of slots 110 is designed to be consistent with the number of pins 210; the inner wall of the slot 110 is metallized, that is, the slot is metallized, for example, the copper on the inner wall of the slot 110 has a thickness of 18 μm to 22 μm; the pads 120 arranged on opposite sides of the slot 110 in its length direction have a width ranging from 0.8 μm to 1.5 μm; and a thickness of the feeding power dividing plate 100 and the height of the pin 210 of the isolating bar 200 are designed according to actual situations, to ensure that the pin 210 is exposed from the surface of the feeding power dividing plate 100 by 0.3 mm to 0.7 mm.

It can be understood that when the isolating bar 200 is welded to the feed power dividing plate 100, the following welding method may be adopted: first, solder paste is printed on the feed power dividing plate 100, where the solder paste has a thickness of 0.25 mm; then, the pin 210 of the isolating bar 200 is inserted into the slot 110 of the power dividing plate, and the isolating bar is fixed by means of auxiliary tooling to prevent the isolating bar 200 from tilting; and finally, an SMT through-hole reflow soldering process is adopted, where an assembled single board is placed into an SMT reflow oven, with an oven temperature curve set according to measured conditions, and the welding of the isolating bar 200 is completed after the single board comes out of the SMT reflow oven. A finished product after welding is shown in the overall structure diagram as shown in FIG. 2.

It can be understood that the isolating bar 200 is perpendicularly welded to the feeding power dividing plate 100. In an embodiment, the isolating bar 200 is placed on the pads 120 of the feeding power dividing plate 100, the pin 210 of the isolating bar 200 is inserted into slot 110 of the feeding power dividing plate 100, and the isolating bar 200 is kept perpendicular to the feeding power dividing plate 100 and is fixed by means of auxiliary tooling.

It can be understood that the pads 120 are provided on the two sides in the length direction of the slot 110 to weld the isolating bar 200 and the feeding power dividing plate 100 together. In an embodiment, the pin 210 of the isolating bar 200 is inserted into the slot 110 of the feeding power dividing plate 100, and the isolating bar 200 is welded to the feeding power dividing plate 100 through the pads 120 based on the through-hole reflow soldering process.

It can be understood that the surface of the isolating bar 200 is cladded with copper to match the metallization of the inner wall of the slot 110.

It can be understood that the surface of the isolating bar 200 is subjected to immersion tin treatment. Compared with the welding method in some technical schemes, i.e., soldering iron drag welding plus tin wire drag welding, which leads to a large amount of tin and high solder wicking, the immersion tin treatment performed on the surface of the isolating bar 200 in the present disclosure has an advantage of reduced use amount of tin.

It can be understood that the isolating bar 200 may be made of a PCB.

It can be understood that for the metallization of the inner wall of the slot 110, the inner wall of the slot 110 may be provided with a copper layer, with a thickness of the copper layer ranging from 18 μm to 22 μm.

It can be understood that, in order to facilitate the insertion of the pin 210 into the slot 110, the slot 110 is slightly wider than the isolating bar 200, and slightly longer than the pin 210, and the height of the pin 210 is slightly greater than a depth of the slot 110, to ensure that the pin 210 is exposed from the surface of the feeding power dividing plate 100 by 0.3 mm to 0.7 mm.

Based on this, compared with the manual welding method in some technical schemes, the present disclosure has the advantages that batch automatic production can be achieved, and production efficiency can be improved, thereby reducing the production and manufacturing costs of products, and improving the quality stability of products.

An embodiment of the present disclosure provides an electronic device including the above-mentioned antenna structure.

In an embodiment, because the electronic device adopts the antenna structure, the electronic device can achieve the same technical effect as the antenna structure. The antenna structure of the electronic device includes a feed power dividing plate and an isolating bar. The feed power dividing plate is provided with a slot, an inner wall of the slot is metallized, and pads are arranged on two sides of the slot. The isolating bar is provided with a pin configured to be inserted into the slot, and the isolating bar is welded to the feed power dividing plate through the pads based on a through-hole reflow soldering process. Based on this, the feed power dividing plate of the present disclosure is provided with a slot, an inner wall of the slot is metallized, pads are arranged on two sides of the slot. The isolating bar is provided with a pin which, when welding, are inserted into the slot, and then the isolating bar is welded to the feed power dividing plate through the pads based on the through-hole reflow soldering process. Compared with the manual welding method in some technical schemes, the present disclosure has the advantages that batch automatic production can be achieved, and production efficiency can be improved, thereby reducing the production and manufacturing costs of products, and improving the quality stability of products.

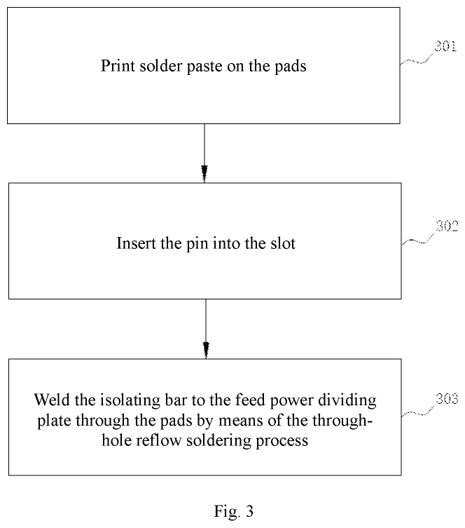

As shown in FIG. 3, an embodiment of the present disclosure provides a manufacturing method for the antenna structure. The antenna structure includes a feed power dividing plate and an isolating bar. The feed power dividing plate is provided with a slot, an inner wall of the slot is metallized, pads are arranged on two sides of the slot, and the isolating bar is provided with a pin. The manufacturing method includes, but not limited to, the following steps.

In a step of 301, solder paste is printed on the pads.

In a step of 302, the pin is inserted into the slot.

In a step of 303, the isolating bar is welded to the feed power dividing plate through the pads by means of a through-hole reflow soldering process.

During manufacturing, solder paste is printed on the pads, then the pin is inserted into the slot, and then the isolating bar is welded to the feed power dividing plate through the pads by means of the through-hole reflow soldering process. A finished product after welding is shown in the overall structure diagram as shown in FIG. 2. Compared with the welding process (manual welding process) in some technical schemes, this welding method adopts the through-hole reflow technology, which is applicable to automatic production of SMT equipment. Due to the fact that the pin designed on the isolating bar can be inserted into the slot of the power dividing plate, the slot is metallized, and the through-hole reflow soldering process is adopted for welding after the pin is inserted into the slot, compared with the manual welding method, i.e., soldering iron drag welding plus tin wire drag welding, the welding method of the present disclosure has the advantages of reduced use amount of tin, firm and reliable welding, addressing the problems that the manual welding method in some technical schemes is not conducive to automatic production, requires high labor input, and has unsatisfactory quality consistency. The SMT welding method used in the present disclosure has high welding efficiency, is suitable for mass production, can save costs, achieves the effect of design and process innovation, and facilitates layout in the supply chain, which helps to accelerate the application scale of 5G base station antennas to expand the scale of industrial chains.

It should be noted that the design specifications of the isolating bar may be made according to actual needs. In order to facilitate SMT welding, the design specifications of the isolating bar may be as follows: the isolating bar has a height between 8 mm and 15 mm, a thickness between 1 mm and 2 mm, and a length designed according to actual needs; the pin of the isolating bar has a height between 1 mm and 2 mm and a length between 6 mm and 15 mm, and the number of pins is designed to be between 2 and 4. Moreover, the isolating bar may be made of a PCB. In addition, the isolating bar is cladded with copper on the two sides, with a copper thickness ranging from 17 μm to 35 μm, and is subjected to immersion tin surface treatment.

It should be noted that the design specifications of the feeding power dividing plate should be matched with the design specifications of the isolating bar. Based on this, the design specifications of the isolating bar may be as follows: the slot of the feed power dividing plate has a width 0.25 mm greater than the thickness of the isolating bar, the feed power dividing plate has a length 0.5 mm greater than that of the pin, and the number of slots is designed to be consistent with the number of pins; the inner wall of the slot is metallized, that is, the slot is metallized, for example, the copper on the inner wall of the slot has a thickness of 18 μm to 22 μm; the pads arranged on opposite sides of the slot in its length direction have a width ranging from 0.8 μm to 1.5 μm; a thickness of the feeding power dividing plate and the height of the pin of the isolating bar are designed according to actual situations, to ensure that the pin is exposed from the surface of the feeding power dividing plate by 0.3 mm to 0.7 mm.

It can be understood that after step 302, the method further includes a following step of:

perpendicularly fixing the isolating bar to the feed power dividing plate by means of auxiliary tooling.

The pin of the isolating bar is inserted into the slot of the feeding power dividing plate, and the isolating bar is fixed by means of auxiliary tooling to prevent the isolating bar from tilting, so as to ensure that the isolating bar is perpendicularly fixed to the feeding power dividing plate.

It can be understood that step 303 may include, but not limited to, a following step of:

welding the isolating bar to the feed power dividing plate through the pads by means of a SMT reflow oven.

For the through-hole reflow soldering process, the isolating bar may be welded to the feed power dividing plate through the pads by means of the SMT reflow oven. Due to the use of conventional SMT reflow soldering equipment for mass production, the welding method of the present disclosure has the advantages of high automatic production efficiency, low labor input, and stable quality.

This welding method adopts the through-hole reflow soldering process, which is applicable to automatic production of SMT equipment. Due to the fact that the pin designed on the isolating bar is inserted into the slot of the power dividing plate, the slot is metallized, and the through-hole reflow soldering process is adopted for welding after the pin is inserted into the slot, compared with the manual welding method, i.e., soldering iron drag welding plus tin wire drag welding, the welding method of the present disclosure has the advantages of reduced use amount of tin, firm and reliable welding, addressing the problems that the manual welding method in some technical schemes is not conducive to automatic production, requires high labor input, and has unsatisfactory quality consistency. The SMT welding method used in the present disclosure has high welding efficiency, is suitable for mass production, can save costs, achieves the effect of design and process innovation, and facilitates layout in the supply chain, which helps to accelerate the application scale of 5G base station antennas to expand the scale of industrial chains.

Embodiments of the present disclosure include an antenna structure and a manufacturing method therefor. The antenna structure includes a feed power dividing plate and an isolating bar. The feed power dividing plate is provided with a slot, an inner wall of the slot is metallized, and pads are arranged on two sides of the slot. The isolating bar is provided with a pin configured to be inserted into the slot, and the isolating bar is welded to the feed power dividing plate through the pads based on the through-hole reflow soldering process. Based on this, the feed power dividing plate of the present disclosure is provided with a slot, an inner wall of the slot is metallized, pads are arranged on two sides of the slot, the isolating bar is provided with a pin which, during welding, is inserted into the slot, and then the isolating bar is welded to the feed power dividing plate through the pads based on the through-hole reflow soldering process. Compared with the manual welding method in some technical schemes, the present disclosure has the advantages that batch automatic production can be achieved, and production efficiency can be improved, thereby reducing the production and manufacturing costs of products, and improving the quality stability of products.

The above is a detailed description of some implementations of the present disclosure, but the present disclosure is not limited to the above implementations. Those having ordinary skills in this art can make various equivalent modifications or substitutions without violating the sharing conditions of the scope of the present disclosure, and these equivalent modifications or substitutions are included in the scope defined by the claims of the present disclosure.

1. An antenna structure, comprising:
a feed power dividing plate provided with a slot, wherein an inner wall of the slot is metallized, and pads are arranged on two sides of the slot; and
an isolating bar provided with a pin configured to be inserted into the slot, the isolating bar being welded to the feed power dividing plate through the pads based on a through-hole reflow soldering process.

2. The antenna structure of claim 1, wherein the isolating bar is perpendicularly welded to the feed power dividing plate.

3. The antenna structure of claim 1, wherein the pads are arranged on two sides in a length direction of the slot.

4. The antenna structure of claim 1, wherein a surface of the isolating bar is cladded with copper.

5. The antenna structure of claim 4, wherein the surface of the isolating bar is subjected to immersion tin treatment.

6. The antenna structure of claim 1, wherein the isolating bar is made of a Printed Circuit Board.

7. The antenna structure of claim 1, wherein the inner wall of the slot is provided with a copper layer.

8. The antenna structure of claim 1, wherein the slot has a greater width than the isolating bar.

9. The antenna structure of claim 8, wherein the slot has a greater length than the pin.

10. The antenna structure of claim 9, wherein the pin has a height greater than a depth of the slot.

11. An electronic device, comprising an antenna structure, the antenna structure comprising:
a feed power dividing plate provided with a slot, wherein an inner wall of the slot is metallized, and pads are arranged on two sides of the slot; and
an isolating bar provided with a pin configured to be inserted into the slot, the isolating bar being welded to the feed power dividing plate through the pads based on a through-hole reflow soldering process.

12. A manufacturing method for an antenna structure, wherein the antenna structure comprises a feed power dividing plate and an isolating bar, the feed power dividing plate is provided with a slot, an inner wall of the slot is metallized, pads are arranged on two sides of the slot, and the isolating bar is provided with a pin, the manufacturing method comprising:
printing solder paste on the pads;
inserting the pin into the slot; and
welding the isolating bar to the feed power dividing plate through the pads by means of a through-hole reflow soldering process.

13. The manufacturing method of claim 12, wherein after inserting the pin into the slot, the method further comprises:
perpendicularly fixing the isolating bar to the feed power dividing plate by means of auxiliary tooling.

14. The manufacturing method of claim 12, wherein welding the isolating bar to the feed power dividing plate through the pads by means of the through-hole reflow soldering process comprises:
welding the isolating bar to the feed power dividing plate through the pads by means of a Surface Mounted Technology (SMT) reflow oven.
